(19) United States
(12) Patent Application Publication
(10) Pub. No.: US 2003/0213078 A1
(43) Pub. Date: Nov. 20, 2003

(54) Fish tank cleaning device

(76) Inventor: David P. Kristofek, Bolingbrook, IL (US)

Correspondence Address: Ernest S. Kettelson, KETTELSON LAW OFFICES, LTD., Wynderidge Place, Post Office Box 2517, Joliet, IL, 60434, US

(21) Appl. No.: 10/144,547

(22) Filed: May 14, 2002

(51) Int. Cl. A01K 63/04; B08B 1/04

(52) U.S. Cl. 15/97.1; 119/264; 15/28; 15/1.7

(57) ABSTRACT

A fish tank cleaning device comprising an elongated telescoping housing and telescoping handle having an electric motor and batteries in a waterproof housing to drive a rotatable disk and releasable cleaning member thereon positioned outside of the housing to rotate in a plane that is substantially parallel to the longitudinal axis of the elongated housing and handle. The telescoping handle may be extended far enough for the lower end of the housing having the rotatable disk and cleaning member to reach the bottom of the fish tank while the upper end of the handle is above the upper edge of the fish tank where it can be held by the user above the water in the tank and manipulated by the user to position the rotating cleaning member against the surfaces of the fish tank to be cleaned.

### FIELD OF THE INVENTION

This invention relates to the field of devices to clean fish tanks, with particular reference to a portable powered cleaning tool that can completely clean the inwardly facing surfaces of the glass or otherwise transparent side walls, not only from side edge to side edge but from the top to the very bottom. The cleaning tool includes a telescoping handle member that enables moving the cleaning head portion of the tool from the top to the very bottom of the fish tank while the cleaning head continues to operate.

### BACKGROUND OF THE INVENTION

The prior art method of cleaning fish tanks is to use a manual non-powered brush or cleaning cloth held by the workman who manually dips the cloth or cleaning head portion of the brush into the water of the tank and scrubs it against the inner surfaces of the side walls. This usually leaves streaks and results in uneven cleaning of the fish tank walls.

Cleaning fish tanks this prior art way is also messy. The use of a brillo-type pad on a stick or handle creates unwanted mess and requires the workman to place his hands or arms into the tank. This prior art way of manually cleaning the fish tanks requires aggressive manual scrubbing action in order to wipe the algae off the glass walls. Since the normal water level of fish tanks is near the top, aggressive scrubbing action by the workman's hands and arms creates waves and other water motion causing the water to spill over the upper edge of the fish tank. Some of the fish tanks, particularly the larger ones of one hundred fifty gallons or more, contain dangerous fish that can attack and cause harm to a person who has stuck his arm and hand down therein.

Magnets cleaners which use rare earth magnets are also known to the prior art for cleaning fish tanks. However, they tend to scratch those fish tank walls that are made of acrylic, and they can cause those that are made of glass to crack. The magnets are so powerful and require such physical effort to manipulate and move around that it is easy to crack the glass walls if the workman is not particularly careful.

Another prior art alternative is to empty the water from the fish tank, after which ordinary powered brushes and cleaning devices used for other purposes can be used. However, when the water is removed, the fish themselves have to be removed from the tank and placed elsewhere until the glass walls of the tank have been cleaned. Then new water suitable for the fish has to be obtained to refill the tank before the fish can be placed back in. During that process impurities can enter the tank and the refill water which may result in killing the fish when they are finally placed back in the tank.

The fish tank cleaning device in accordance with this invention includes a waterproof housing for the electric motor which powers a rotatable cleaning head that can be lowered into the water of the fish tank all the way to the bottom. A telescoping handle portion of the cleaning device enables lowering the water-proof operating head portion of the cleaning device to whatever depth necessary, with the workman holding the upper portion of the handle above the tank which he can then direct and manipulate as necessary against the inner surfaces of the fish tank walls. Prior art cleaning devices of the ordinary kind used for general purpose cleaning of items other than fish tanks include those disclosed in the following U.S. Pat. Nos.

| | | |
|---|---|---|
| 6,058,542 | 5,706,541 | 5,317,776 |
| 5,978,999 | 5,706,539 | 5,289,605 |
| 5,975,022 | 5,471,695 | 4,158,246 |
| 5,870,790 | 5,381,578 | 3,688,139 |
| 5,718,014 | 5,353,461 | 2,899,063 |

Copies of those United States patents are readily available to those having an interest therein at a number of locations throughout the United States, including public libraries in a number of the larger cities and in the United States Patent and Trademark Office in Washington, D. C.

### SUMMARY OF THE INVENTION

The fish tank cleaning device in accordance with the present invention provides a number of advantages and improvements over prior art methods. It comprises a battery operated rotating cleaning head mounted on a drive shaft that extends outwardly from the lower end of a waterproof housing. The drive shaft is driven by a battery powered electric motor mounted inside of the waterproof housing connected to a gear box which provides relatively low speed high torque power to the drive shaft and the rotating cleaning head which are rotated at about 150 to 185 rpm. A variety of different cleaning pads may be secured to the rotating cleaning head. Course pads may be used for heavy algae accumulation on the fish tank walls. Smooth sponge pads may be used for routine maintenance. The rotating cleaning head may be connected to the drive shaft by a swivel or universal joint connection that enables pivoting the head at different angles to make it easier to clean irregular or awkward surfaces.

### BRIEF DESCRIPTION OF THE DRAWING

FIG. 1 is a side elevation view of a telescoping fish tank cleaning device in accordance with this invention.

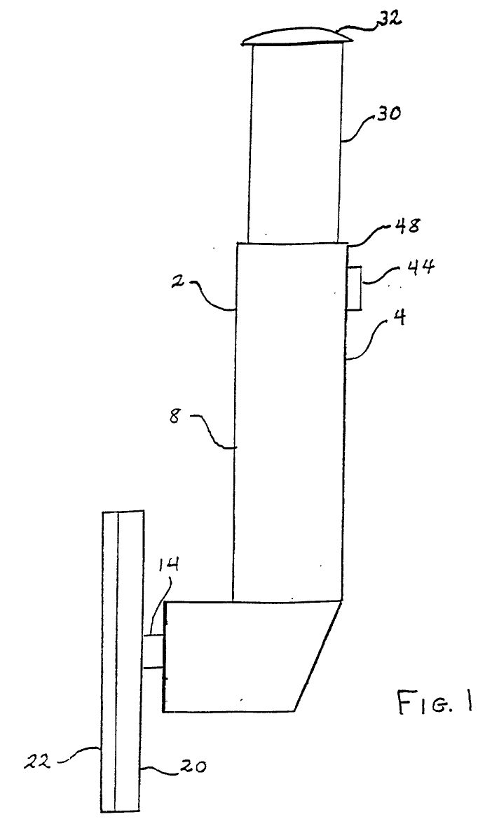

FIG. 2 is a side elevation view of a telescoping fish tank cleaning device as seen in FIG. 1, but with the lower body portion shown as being transparent to illustrate the interior and components therein, and with the upper telescoping handle portion shown partially in cross section to illustrate its annular side wall.

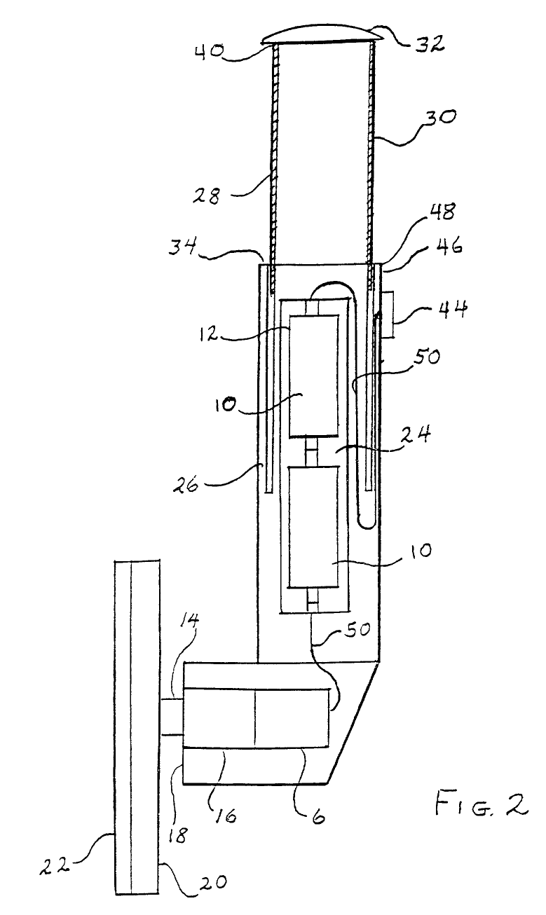

FIG. 3 is a front elevation view of a telescoping fish tank cleaning device in accordance with this invention.

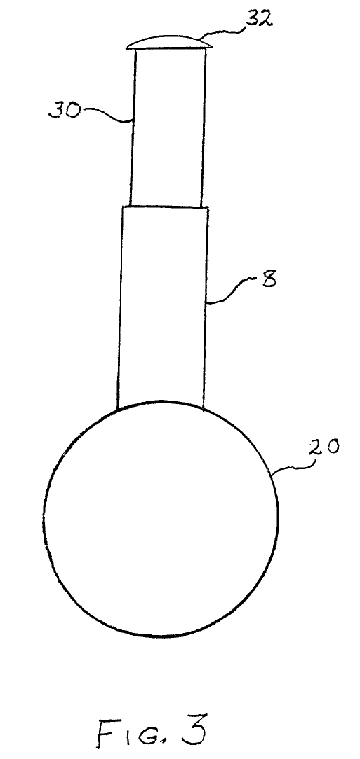

FIG. 4 is a side elevation view of a fish tank with a telescoping fish tank cleaning device in accordance with this invention shown inserted therein and in place against one of the side walls of the fish tank in position for cleaning the side wall.

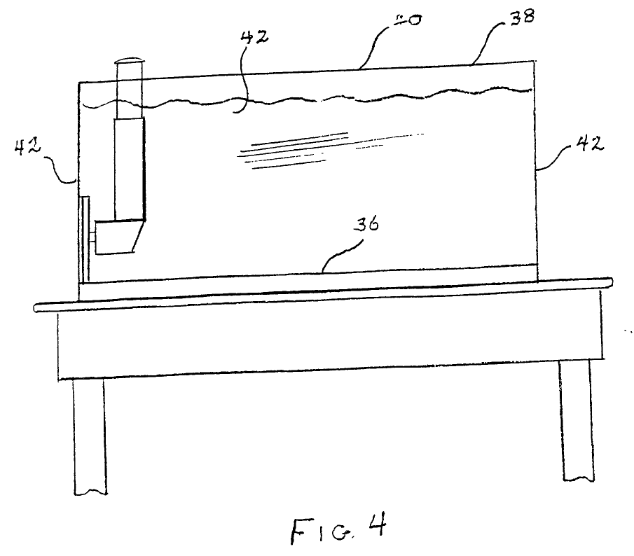

### DESCRIPTION OF PREFERRED EMBODIMENT

A fish tank cleaning device in accordance with this invention comprises a powered hand tool 2, having an elongated telescoping housing 4 with an electric motor 6 mounted in its lower receiving portion 8 powered by a pair of rechargeable batteries 10 in a battery pack 12 also mounted in the lower receiving portion 8 of the housing 4. A drive shaft 14 rotated by the electric motor 6 through a gear box 16 extends through the lower end wall 18 of the telescoping housing 4, having a rotary disk 20 secured to the outer end of the drive shaft 14. Cleaning pads 22 of various kinds and textures may be removably mounted on the rotary disk 20, the kind and texture of the cleaning pads 22 ranging from less abrasive for routine maintenance to more abrasive for harder to clean surfaces during more aggressive cleaning operations. The outwardly facing side of the rotary disk 20 may have one part of a releasable connecting means thereon, such as a plurality of tiny flexible loops. The inwardly facing side of the cleaning pad 22 may have the corresponding other part of a releasable connecting means thereon, such as a plurality of tiny flexible hooks, which when pressed against the outwardly facing side of the rotary disk 20 releasably interconnect with the tiny flexible loops thereon to hold the cleaning pad 22 in place. Other types of releasable connecting means may be used to releasably connect the cleaning pad 22 to the rotary disk 20.

The lower portion 8 of the telescoping housing 4 includes a waterproof chamber 24 in which the battery pack 12 and rechargeable batteries 10 are positioned. An annular receiving groove 26 is provided in the lower portion 8 of the housing 4, positioned radially outward from the waterproof chamber 24. The annular receiving groove 26 extends downwardly into the lower portion 8 of the housing 4, to snugly receive the elongated annular side wall 28 of the telescoping handle 30 of the upper portion of the telescoping housing 4. The telescoping handle 30 includes a cap 32 at its upper end, and is slidable into and out of the receiving groove 26 to a fully inserted position at which time the handle cap 32 is adjacent the upper edge 34 of the lower portion 8 of the housing 4, from a fully extended position at which time the handle cap 32 is remote therefrom.

A one hundred fifty gallon aquarium or fish tank 38 may have side walls about thirty inches high. The length of the telescoping housing 4 when the handle 30 is in its fully extended position may therefore be slightly more than thirty inches, such as thirty-four inches, or whatever length needed for the lower end wall 18 to reach the bottom wall 36 of a fish tank 38 when the upper end of the telescoping handle 30 and its cap 32 are above the upper edge 40 of the fish tank 38. The workman may thus grasp the handle 30 above the upper edge of the fish tank and manipulate the lower end of the housing 4 and its rotating disk 20 with a cleaning pad 22 thereon against all portions of the fish tank side walls 42 to clean them from top to bottom as well as from side to side. The telescoping handle 30 may be pushed inward toward its retracted or inserted position when a shorter overall length of the tool 2 is needed to clean fish tanks having shorter side walls. The telescoping housing 4 and telescoping handle 30 may be whatever length needed to reach the bottom portion of the fish tank side walls 42 of any size fish tank.

An electrical switch 44 is provided on the outer surface 46 of the cylindrical side wall 48 of the housing 4 near its upper edge for easy access by the user, connected in the battery and motor circuit 50, to turn the electric motor 6 off and on.

The drive shaft 14 of the electric motor 6 extends at a substantially right angle to the longitudinal axis of the elongated telescoping housing 4. The rotary disk 20 and cleaning pads 22 extend at a substantially right angle to the drive shaft 14 when secured thereon. Thus, when the powered hand tool 2 and fish tank cleaning device in accordance with this invention is lowered vertically into a fish tank, the rotary disk 20 and cleaning pad 22 thereon are substantially parallel to the side walls 42 of the fish tank toward which they are facing.

Use of the fish tank cleaning device in accordance with this invention makes the job relatively easy. To clean the side walls of a thirty inch high aquarium, sitting on a stand or shelf about thirty inches above the floor for a total height of about sixty inches or five feet, the user grasps the upper portion of the telescoping handle 30 and extends it to its full length of about thirty four inches between the cap 32 thereof and the lower end wall 18 of the lower portion of the telescoping housing 4. He then moves the switch to the on position to start the motor and places the lower end of the telescoping housing 4 having the now rotating rotary disk 20 and a cleaning pad 22 thereon down into the tank until it approaches the bottom wall 36 thereof. The upper end of the telescoping handle 30 is at such time above the upper edge 40 of the fish tank 38 where the user can hold it without having to lower his hand and arm into the water. While holding the device in this manner, the user can guide the lower end with its rotating disk 20 and cleaning pad 22 to all portions of the side walls and other areas of the fish tank that need cleaning, and let the rotating disk and cleaning pad do the job. There are no wet arms, no splashing water, no wet carpets, no cracked glass, and no physical strain on the part of the workman when using the fish tank cleaning device in accordance with this invention.

The electric motor 6 suitable for use in this invention is preferably a three volt motor, and the batteries 10 comprise two one-and-a-half volt batteries. The gear box 16 connected to the drive shaft of the motor 6 rotates the rotary disk 20 connected to the drive shaft 14 at a preferred speed of one hundred fifty to one hundred eighty five revolutions per minute. This speed of rotation is sufficient to enable the cleaning pad 22 on the rotary disk 20 to clean the surface against which it is positioned, and yet not so fast that it unduly disturbs the water in the fish tank that might otherwise scare or disturb the fish therein, and might otherwise cause the water to splash.

I claim:

1. A fish tank cleaning device comprising an elongated tool body having an upper end and a lower end and a longitudinal axis extending therebetween, a waterproof chamber therein, a motor and means to power said motor for rotational movement in said waterproof chamber, rotational cleaning means mounted outside of said elongated tool body at its said lower end and connected for rotation to said motor, said rotational cleaning means including a cleaning member positioned for contact against the surface of a fish tank wall which extends in a vertical plane substantially parallel to said longitudinal axis of said elongated tool body when said fish tank cleaning device is lowered into said fish tank.

2. A fish tank cleaning device as set forth in claim 1, wherein said elongated tool body comprises an elongated telescoping housing having a telescoping handle receivable in said elongated telescoping housing and extendable outwardly therefrom.

3. A fish tank cleaning device as set forth in claim 1, wherein said motor comprises an electrical motor, said means to power said motor includes a battery mounted in said waterproof housing.

4. A fish tank cleaning device as set forth in claim 1, wherein said motor includes a drive shaft, said rotational cleaning means includes a rotatable member mounted for rotation by said motor.

5. A fish tank cleaning device as set forth in claim 1, wherein said cleaning member includes an inwardly facing side, said rotatable member includes an outwardly facing side, releasable connecting means to releasably connect said inwardly facing side of said cleaning member to said outwardly facing side of said rotatable member.

6. A fish tank cleaning device as set forth in claim 5, wherein said releasable connecting means includes a plurality of tiny flexible loops on one of said inwardly facing side of said cleaning member and said outwardly facing side of said rotatable member, a plurality of tiny flexible hooks on the other one of said inwardly facing side of said cleaning member and said outwardly facing side of said rotatable member, said tiny flexible hooks releasably interconnecting with said tiny flexible loops when said inwardly facing side of said cleaning member is placed against said outwardly facing side of said rotatable member to releasably hold said cleaning member in place on said rotatable member when placed in contact with a surface of the fish tank to be cleaned and rotated while held thereagainst.

7. A fish tank cleaning device as set forth in claim 1, wherein said rotational cleaning means is rotated at no less than one hundred and fifty revolutions per minute and no more than one hundred and eighty five revolutions per minute during normal cleaning operation.

8. A fish tank cleaning device as set forth in claim 2, wherein said rotational cleaning means is rotated at no less than one hundred and fifty revolutions per minute and no more than one hundred and eighty five revolutions per minute during normal cleaning operation.
